(19) United States
(12) Patent Application Publication
(10) Pub. No.: US 2003/0212951 A1
(43) Pub. Date: Nov. 13, 2003

(54) Apparatus for and method of generating soft output of signal passing through a channel

(75) Inventors: Ki-hyun Kim, Daejeon Metropolitan-City (KR); Sung-hyu Han, Seoul (KR); In-sik Park, Gyeonggi-do (KR); Jae-seong Shim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/425,876

(22) Filed: Apr. 30, 2003

(30) Foreign Application Priority Data
May 9, 2002 (KR) 2002-25632

(51) Int. Cl. H04L 1/00

(52) U.S. Cl. 714/799

(57) ABSTRACT

An apparatus for and a method of generating a soft output for a discrete input signal passing through a channel. A time at which a code of a value of the input signal is inverted is set as a first reference time. A predetermined number of inversion sections are detected at the first reference time. A second reference time at which the input signal has a discrete value within an inversion section is set. Error paths of target values are calculated at each time. Accumulated errors for the error are calculated. A log likelihood relation (LLR) value is calculated and the values of the input signal within the inversion section of a predetermined range are replaced with the LLR values. Accordingly, soft outputs for the input signal are generated for error paths of only the signals that intersect at a zero point, thereby remarkably reducing calculation time.

### CROSS REFERENCE TO RELATED APPLICATIONS

This application claims the priority of Korean Patent Application No. 2002-25632, filed May 9, 2002 in the Korean Intellectual Property Office, the disclosure of which is incorporated herein by reference.

### BACKGROUND OF THE INVENTION

1. Field of the Invention

The present invention relates to an apparatus for and a method of generating a soft output, and more particularly, to an apparatus for and a method of generating a soft output of a signal that passes through a channel having predetermined characteristics.

2. Description of the Related Art

Conventionally, a soft output of a signal passing through a channel is obtained using a maximum posteriori probability (MAP) algorithm or a soft output viterbi algorithm (SOVA), or by calculating a log likelihood relation (LLR).

The MAP algorithm is an algorithm having a maximum probability that is expressed as P{dₖ=i\observation}, wherein dₖ denotes a kth input and i may be 1 or 0. That is, according to the MAP algorithm, a signal of a regular size is received and a posteriori probability for each bit is calculated. The SOVA algorithm multiplies a result obtained using a viterbi algorithm by a reliability and outputs the result. According to the viterbi algorithm, a final value is obtained through operation of a regular sequence, and thus, updating the reliability of a mean value of the operation is required. The calculation of the LLR is made to detect every possibility for cases that may be output by a channel, and the calculation of the LLR is different from the SOVA algorithm in that the calculation of the LLR detects an output of each bit. The SOVA algorithm calculates a sequence value, which may be output, for a sequence of a regular size.

The above conventional methods are disadvantageous, however, in that excess time is required to obtain a soft output of a signal passing through a channel, because a decoding process is performed in frame units in the case of the MAP algorithm or all error paths and outputs are detected in the case of the SOVA algorithm and the calculation of the LLR. In particular, repetitively performing a decoding process results in an increase in a time delay.

### SUMMARY OF THE INVENTION

To solve the above and/or other related problems, it is an aspect of the present invention to provide a method of setting an error path used in obtaining a soft output of a signal generated in an inter symbol interference (ISI) channel.

It is another aspect of the present invention to provide an apparatus for and method of obtaining a soft output of a signal generated in an ISI channel with a more reduced calculation time than conventional methods.

Additional aspects and/or advantages of the invention will be set forth in part in the description which follows, and, in part, will be obvious from the description, or may be learned by practice of the invention.

To achieve the above and/or other aspects, there is provided a method of setting an error path of a signal, the method comprising inputting a first signal that is a predetermined discrete signal; setting a time at which the first signal has a discrete value as a reference time; and sampling all combinations of a predetermined number of all possible values at times before and after the reference time at which the first signal has the discrete value and the discrete value of the first signal at the reference time.

The inputting of the first signal may further comprise setting a time of a predetermined range that includes a point of times at which a code of the discrete value of the first signal is inverted, and during the setting of the time, setting a time at which the first signal has the discrete value as a reference time within the time of the predetermined range.

To achieve the above and/or other objects, there is also provided a method of generating a soft output of a signal, the method comprising inputting an input signal that is a discrete signal converted from an analog signal passing through a channel having predetermined characteristics such as a recording medium; setting a point in time, as a first reference point, at which a code of a value of the input signal is inverted, and detecting a predetermined number of inversion sections at the first reference point; setting points in time, as second reference points, when the input signal has a discrete value within the inversion section, and calculating all error paths of target values at each time, the target values including the values of the input signal at the second reference points and the values of signals at each time, and the error paths being a set of the target values; calculating accumulated errors for the error paths with the values of input signal within the inversion section and the values of the error paths, and calculating maximum values of the accumulated errors for the error paths at the second reference points; calculating a log likelihood relation (LLR) value using the maximum values at the second reference points; and replacing the values of the input signal within the inversion section of a predetermined range with the LLR values; and outputting the LLR values.

The setting of the instant of time may further comprise setting times at which the input signal has a discrete value as second reference points, and calculating all error paths of target values at the each time, the target values including the values of the input signal at the second reference points and the values of signals at each time, and the error paths being a set of the target values; and the setting of the instants of time may further comprise setting a point in time, at which a code of the value of the input signal is inverted, as a first reference point, and detecting an inversion section where the input signal has a predetermined number of values.

To achieve the above and/or other objects, there is also provided an apparatus for generating a soft output of a signal, the apparatus comprising an inversion section detection unit which receives an input signal and detects an inversion section where the input signal has a predetermined number of values at a first reference point, the input signal being a discrete signal converted from an analog signal passing through a channel having predetermined characteristics, the channel including a recording medium, and the first reference point being a point in time when codes of the values of the input signal are inverted; an accumulated error operation unit which calculates all error paths at second reference points, calculates accumulated errors for the error paths using the values of the input signal within an inversion section and the values of the error paths at the second reference points, and calculates maximum values of accumulated error values for the error paths, the second reference points being points in time where the input signal has discrete values within the inversion section, and the error paths being a set of target values that are values the input signal has at each time and the values of the input signal at the second reference points; an LLR value calculating unit which calculates an LLR value using the maximum values at the second reference points; and a signal value conversion unit which changes the values of the input signal within a predetermined range of the inversion section into the LLR values and outputs the LLR values.

The accumulated error operation unit may receive the input signal that is a discrete signal converted from an analog signal passing through a channel having predetermined characteristics such as a recording medium and calculate all error paths including a set of target values and the values of the input signal at the second reference points, the target values being all possible values the input signal has at each time if the second reference points are each of times where the input signal has the discrete value, the accumulated error operation unit calculating accumulated errors for the error paths using the values of the input signal within the inversion section and the values of the error paths at the second reference points and calculating maximum values of the accumulated errors for the error paths. The inversion section detection unit may detect the inversion section where the input signal has a predetermined number of values at the first reference point, the first reference point being where the code of the value of the input signal is inverted.

### BRIEF DESCRIPTION OF THE DRAWINGS

The above and/or other aspects and advantages of the present invention will become more apparent by describing in detail embodiments thereof with reference to the attached drawings in which:

FIG. 1A is a block diagram of an apparatus for generating a soft output of a signal that passes through a channel according to a first embodiment of the present invention;

FIG. 1B is a block diagram of an apparatus for generating a soft output of a signal that passes through a channel according to a second embodiment of the present invention;

FIG. 2 is a flowchart illustrating a method of generating a soft output of a signal that passes through a channel according to the present invention; and

FIG. 3 is a graph illustrating a comparison of a soft output obtained according to the present invention and a hard output obtained according to a partial response maximum likelihood (PRML).

### DESCRIPTION OF THE PREFERRED EMBODIMENT

Reference will now be made in detail to the present embodiments of the present invention, examples of which are illustrated in the accompanying drawings, wherein like reference numerals refer to like elements throughout.

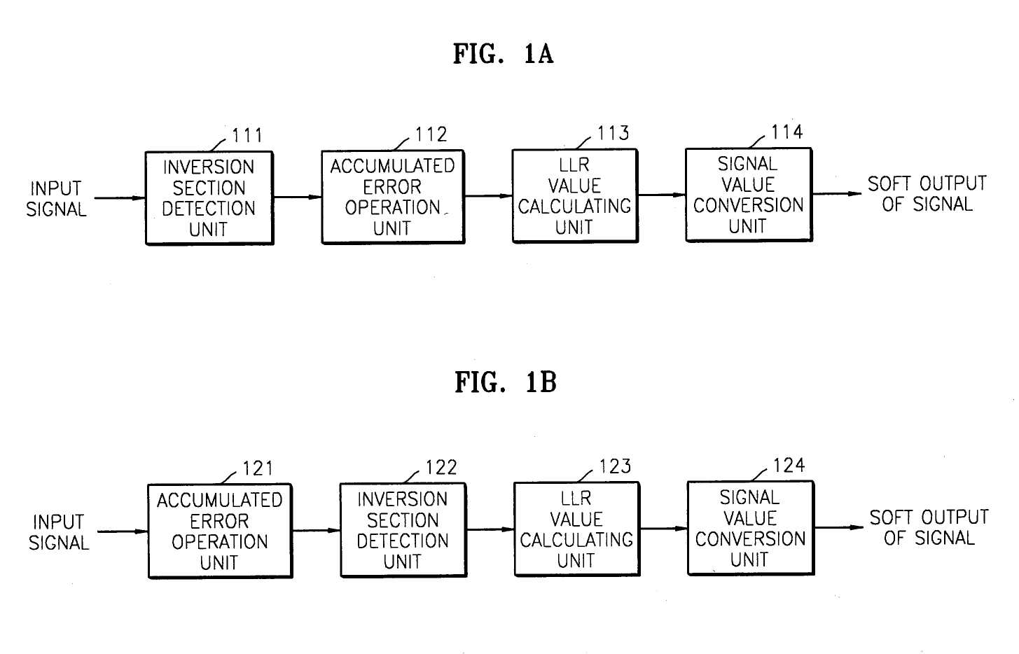

FIGS. 1A and 1B are block diagrams of first and second embodiments, respectively, of an apparatus for generating a soft output according to the present invention. Referring to FIGS. 1A and 1B, a signal r, i.e., a signal in digital form having discrete values (r₁, . . . rₙ . . . r_{N}), is provided as an input signal, wherein r₁, r₂, r₃, . . . rₙ represent time index values corresponding to sampling timing. A digital code for each discrete value includes a portion with defines a magnitude of the of the discrete value and a direction (sign or polarity) of the discrete value. Accumulated error operation units 112 and 121 calculate an error value by the following equation 1:

M(n,k)=−(rₙ−cₖ)² or −|rₙ−cₖ|, (k=1, 2, 3, 4) (1)

wherein r denotes the input signal, c₁, c₂, C₃, and c₄ denote target output values according to a channel, n denotes a signal time that is a reference point for calculating an error value, and rₙ denotes a value of r at the time n. Target output values are output signal levels according to a channel

Next, an accumulated error value for a signal path is calculated by combination of the error value M according to the characteristics of a channel (i.e., the signal value of a given channel) as shown in the following equation 2:

Er_{i,n}= . . . M(n−1, kₙ₋₁)+M(n+1, kₙ₊₁) (2)

where i denotes the number of a signal path (i.e., the number of a signal trace in a trellis) and n denotes a signal time that is a reference point for calculating an error value.

Inversion section detection units 111 and 122 check a code for (rₙ₋₁×rₙ) and a code for rₙ₋₁ to detect a change in the direction of the input signal r, and set an inversion section of a predetermined size that includes values of the input signal r which demonstrate an inversion of direction of the signal r. That is, if (rₙ₋₁×rₙ) is negative and rₙ is positive, r has changed directions from negative to positive in an interval between rₙ₋₁ and rₙ; if (rₙ₋₁×rₙ) is negative and rₙ is negative, r has changed direction from positive to negative in the interval between rₙ₋₁ and rₙ; and if (rₙ₋₁×rₙ) is positive, r has not changed direction in the interval between rₙ₋₁ and rₙ. The predetermined size may be selected from one of a plurality of predetermined sizes according to a time difference between a first signal and a signal having an inverted direction with respect to the first signal.

Log-likelihood-ratio (LLR) calculating units 113 and 132 calculate LLR values. An LLR value is obtained by dividing the input signal r by a probability, i.e., (P(r=1|C)/P(r=0|C)), and taking logarithms of the value. The term 1|C refers to a case where the input is C and the output is 1 and the term 0|C refers to a case where the received value is C and the determined output is 0. To simplify this calculation, a maximum value of an error for each signal path, which is calculated by the accumulated error operation units 112 and 121, is used in the present invention.

Signal value converting units 114 and 124 change the inversion value of the input signal r in the inversion section into the LLR value and output the LLR value.

The locations of the accumulated error operation units 112 and 121, and the locations of the inversion section detection units 111 and 122 may be switched if necessary.

A method of generating a soft output according to the present invention will be now be described. First, an analog signal, which passes through a channel having predetermined characteristics, is converted into a discrete signal and an accumulated error for the path of the input signal is calculated.

For instance, if a number of the channel is 121, target values may be expressed as Cn={1, 0.5, −0.5, 1}. In this case, combinations of four accumulated errors for one path for three signals are expressed in Table 1. Here, inversion of a signal occurs between signal times n−1 and n, where a signal for a signal time n−1 is positive.

TABLE 1

| | n − 2 | n − 1 | n | n + 1 |
|---|---|---|---|---|
| Er_{1,n} | 1 | 0.5 | −0.5 | 1 |
| Er_{2,n} | 0.5 | 0.5 | −0.5 | −0.5 |
| Er_{3,n} | 0.5 | 0.5 | −0.5 | 1 |
| Er_{4,n} | 1 | 0.5 | −0.5 | −0.5 |

Once the combinations illustrated in Table 1 are selected, accumulated errors are calculated by equation, Er_{i,n}=M(n−2,K_{n-2,i})+ . . . +M(n+1,K_{n+1,i}). As a result, when three signals intersect at a zero point, i.e., these signals are inverted, accumulated errors for paths of the three signals are Er_{i,n-1}, Er_{i,n}, and Er_{i,n+1}, respectively.

Thereafter, the location and direction at which a code of the input signal changes are checked. At this time, codes of continuous two signals are checked as described above.

Next, assuming that these signals intersect at the zero point, a maximum one of accumulated error values per signal path is selected. That is, a signal path whose error accumulation is maximum is selected. In the event that the intersection of the signals at the zero point is made between n−1 and n, where a signal for n−1 is positive, maximum values for the accumulated errors Er_{i,n-1}, Er_{i,n}, and Er_{i,n+1} are calculated.

Next, LLR values are calculated using the maximum values per signal path. If the maximum values are MErₙ₋₁, MErₙ, MErₙ₊₁, LLR values are obtained as LLR(n−1)=MErₙ−MErₙ₋₁ and LLR(n)=MErₙ₊₁−MErₙ.

After calculation of the LLR values, signal values before and after the zero point, e.g., the value of an input signal within an inversion section, are replaced with the calculated LLR values and output. That is, the signal values r(n−1) and r(n) are replaced with the LLR values LLR(n−1) and LLR(n) and output.

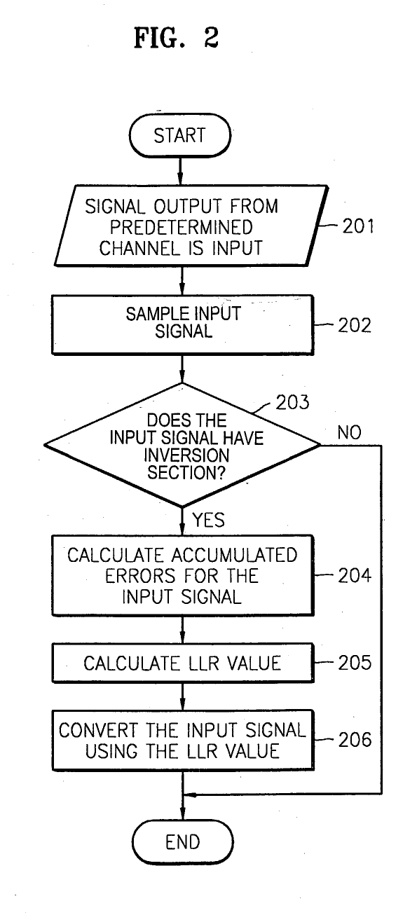

FIG. 2 is a flowchart illustrating a method of generating a soft output of a signal passing through a path according to an embodiment of the present invention.

Referring to FIG. 2, digital signals which represent a signal which has passed through a channel having predetermined characteristics, are input at operation 201. The digital signals are sampled at operation 202. Next, it is checked whether an inversion section is present in the sample of digital signals at operation 203. If the inversion section is present, an accumulated error for one of the sampled digital signals is calculated in operation 204. Next, an LLR value is calculated in operation 205 for the one sampled digital signal, and the one sampled digital signal is converted using the LLR value to generate a soft output thereof in operation 206.

However, if operation 203 determines that no inversion section is present within the sample of digital signals, there is no reason for generating a soft output for the one digital signal and all operations are terminated with respect to the one digital signal. The method then progresses to consider a next sample of the input digital signals.

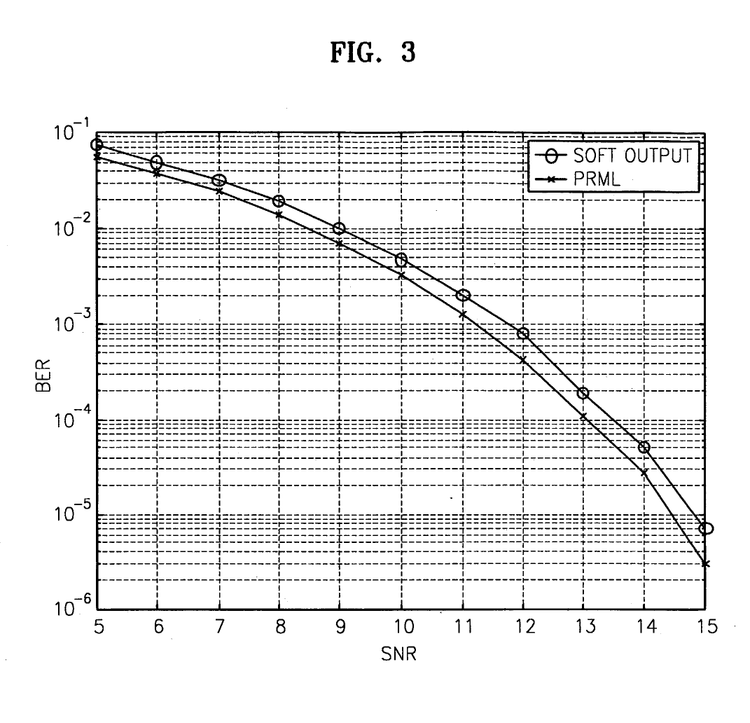

FIG. 3 is a graph illustrating a comparison of a bit error ratio (BER) of a soft output obtained according to the present invention and a hard output obtained according to a partial response maximum likelihood (PRML) if there are 121 channels of data. The soft output shown in FIG. 3 is a result obtained by passing a soft output, according to the present invention, through a hard detector to compare the soft output with a hard output.

The present invention may be embodied as a computer readable code in a computer readable medium. Here, the computer readable medium may be any recording apparatus medium or device capable of storing data which is readable by a computer system, e.g., a read-only memory (ROM), a random access memory (RAM), a compact disc (CD)-ROM, a magnetic tape, a floppy disk, an optical data storage device, etc. Also, the computer readable medium may be a carrier wave that transmits data via a data network, such as for example, the Internet. The computer readable recording medium may be remotely installed in a computer system connected to a network, and stored and accomplished as a computer readable code by a distributed computing environment.

As described above, according to the present invention, soft outputs of signals, which pass through a channel having predetermined characteristics, are generated for error paths of only the signals that intersect at a zero point. Therefore, compared to conventional soft output generation methods, the method according to the present invention does not require performing a decoding process on signals in frame units, thereby remarkably reducing calculation time.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of setting an error path for a signal, comprising:
inputting a first signal;
setting a time at which the first signal has a discrete value as a reference time; and
sampling a predetermined number of values of the first signal at times before and after the reference time at which the first signal has the discrete value and the discrete value of the first signal at the reference time.

2. The method of claim 1, wherein the inputting of the first signal further comprises:
setting a time of a predetermined range that includes points of time at which a code of the discrete value of the first signal is inverted, and
setting the reference time within the time of the predetermined range.

3. A method of generating a soft output of a signal, comprising:
inputting a signal that is a discrete signal converted from an analog signal passing through a channel having predetermined characteristics;
setting a point in time, as a first reference point, at which a code of a value of the input signal is inverted, and detecting a predetermined number of inversion sections relative to the first reference point;
setting points in time, as second reference points, when the input signal has a discrete value within one of the inversion sections, and calculating all error paths of target values at each time, the target values including the values of the input signal at the second reference points and the values of signals at each time, and the error paths being a set of the target values;
calculating accumulated errors for the error paths with the values of input signal within the inversion section and the values of the error paths, and calculating maximum values of the accumulated errors for the error paths at the second reference points;
calculating a log likelihood relation (LLR) value using the maximum values at the second reference points; and
replacing the values of the input signal within the inversion section of a predetermined range with the LLR values and outputting the LLR values.

4. The method of claim 3, wherein:
the setting of each point in time further comprises setting a time at which the input signal has a discrete value as a corresponding second reference point, and calculating all error paths of a target value at the each time, the target value including the value of the input signal at the corresponding second reference point and the corresponding signal value at the corresponding time, and the error paths being a set of the target values; and
the setting of each point in time further comprises setting a point in time, at which a code of the value of the input signal is inverted, as the first reference point, and detecting an inversion section where the input signal has a predetermined number of values.

5. An apparatus for generating a soft output of an input signal, comprising:
an inversion section detection unit which detects an inversion section where the input signal has a predetermined number of values at a first reference point, the input signal being a discrete signal converted from an analog signal passing through a channel having predetermined characteristics, and the first reference point being a point in time when codes of the values of the input signal are inverted;
an accumulated error operation unit which:
calculates all error paths at second reference points,
calculates accumulated errors for the error paths using the values of the input signal within an inversion section and the values of the error paths at the second reference points, and
calculates maximum values of accumulated error values for the error paths, the second reference points being points in time when the input signal has discrete values within the inversion section, and the error paths being a set of target values that are values the input signal has at each time and the values of the input signal at the second reference points;
an LLR value calculating unit which calculates an LLR value using the maximum values at the second reference points; and
a signal value conversion unit which changes the values of the input signal within a predetermined range of the inversion section into the LLR values and outputs the LLR values.

6. An apparatus for generating a soft output of an input signal, comprising:
an accumulated error operation unit which:
receives an input signal that is a discrete signal converted from an analog signal passing through a channel having predetermined characteristics,
calculates all error paths including a set of target values and values of the input signal at second reference points, the target values being all possible values the input signal has at each time if the second reference points are each of times when the input signal has the discrete value,
calculates accumulated errors for the error paths using the values of the input signal within the inversion section and the values of the error paths at the second reference points, and
calculates maximum values of the accumulated errors for the error paths;
an inversion section detection unit which detects an inversion section where the input signal has a predetermined number of values at the first reference point, the first reference point being where the code of the value of the input signal is inverted;
an LLR value calculating unit which calculates an LLR value using the maximum values at the second reference points; and
a signal value conversion unit which changes the values of the input signal within a predetermined range of the inversion section into the LLR values and outputs the LLR values.

7. A computer-readable recording medium, comprising:
a data storage area; and
instructions stored in the data storage area which enable a computer to set an error path for a signal, the stored instructions comprising:
instructions for inputting a first signal,
instructions for setting a time at which the first signal has a discrete value as a reference time, and
instructions for sampling a predetermined number of values of the first signal at times before and after the reference time at which the first signal has the discrete value and the discrete value of the first signal at the reference time.

8. The computer-readable recording medium of claim 7, wherein the instructions for the inputting of the first signal further comprise:
instructions for setting a time of a predetermined range that includes points of time at which a code of the discrete value of the first signal is inverted, and
instructions for setting the reference time within the time of the predetermined range.

9. A computer-readable recording medium, comprising:
a data storage area; and
instructions stored in the data storage area which enable a computer to generate a soft output of a signal, the instructions comprising:
instructions for inputting a signal that is a discrete signal converted from an analog signal passing through a channel having predetermined characteristics;
instructions for setting a point in time, as a first reference point, at which a code of a value of the input signal is inverted, and detecting a predetermined number of inversion sections relative to the first reference point;
instructions for setting points in time, as second reference points, when the input signal has a discrete value within one of the inversion sections, and calculating all error paths of target values at each time, the target values including the values of the input signal at the second reference points and the values of signals at each time, and the error paths being a set of the target values;
instructions for calculating accumulated errors for the error paths with the values of input signal within the inversion section and the values of the error paths, and calculating maximum values of the accumulated errors for the error paths at the second reference points;
instructions for calculating a log likelihood relation (LLR) value using the maximum values at the second reference points; and
instructions for replacing the values of the input signal within the inversion section of a predetermined range with the LLR values and outputting the LLR values.

10. The computer-readable recording medium of claim 9, wherein:
the instructions for the setting of each point in time as second reference points further comprise:
instructions for setting a time at which the input signal has, a discrete value as a corresponding second reference point, and
instructions for calculating all error paths of a target value at each time, the target value including the value of the input signal at the corresponding second reference point and the corresponding signal value at the corresponding time, and the error paths being a set of the target values; and
the instructions for the setting of each point in time as the first reference point further comprise:
instructions for setting a point in time, at which a code of the value of the input signal is inverted, as the first reference point, and
instructions for detecting an inversion section where the input signal has a predetermined number of values.

11. A method of generating a soft output of a signal, comprising:
sampling an input digital signal;
checking whether an inversion section is present in the sample of digital signals;
calculating an accumulated error for one of the sample digital signals, if the inversion section is present;
calculating an log likelihood relation (LLR) value for the one sampled digital signal; and
converting the one sampled digital signal using the LLR value, to generate the soft output of the one digital signal.

12. The method of claim 11, wherein the checking whether an inversion section is present comprises:
comparing a code for (rₙ₋₁×rₙ) and a code for rₙ₋₁ to detect a change in a direction of the input signal, where rₙ and rₙ₋₁ represent the digital signal and a previous digital signal, respectively.
